(19) United States
(12) Patent Application Publication
(10) Pub. No.: US 2020/0086463 A1
(43) Pub. Date: Mar. 19, 2020

(54) MAGNETIC TOOL CONNECTOR

(71) Applicant: JEI MOU INDUSTRIAL CO., LTD., Taichung City (TW)

(72) Inventor: Po-Shen Chen, Taichung City (TW)

(21) Appl. No.: 16/690,343

(22) Filed: Nov. 21, 2019

Related U.S. Application Data
(63) Continuation-in-part of application No. 15/661,038, filed on Jul. 27, 2017.

(30) Foreign Application Priority Data
Aug. 18, 2016 (TW) 105126460
Jan. 4, 2019 (TW) 108200091

(51) Int. Cl. B25B 23/12; B25B 23/00

(52) U.S. Cl. CPC B25B 23/12; B25B 23/0035

(57) ABSTRACT

A magnetic tool connector has a main body including a working end. The working end defines a first chamber and second chamber. The first chamber is configured to receive a flat head fastener. The second chamber having an opening at an end edge of the first chamber. The end edge of the first chamber defines an abutting surface against which the flat head fastener disposed within the first chamber abuts horizontally. A magnetic assembly is slidably coupled to the main body and includes a magnet. The magnetic assembly is movable between a first position in which the magnet is located outside of the second chamber and a second position in which the magnet is located within the second chamber.

### CROSS-REFERENCE

The present application is a continuation-in-part application of U.S. patent application Ser. No. 15/661,038, filed on Jul. 27, 2017, of which the entire disclosure is incorporated herein.

### BACKGROUND OF THE INVENTION

### 1. Field of the Invention

The present invention relates to a tool connector and, particularly, to a magnetic tool connector.

### 2. Description of the Related Art

TW Pat. No. 396182 shows a magnetic tool connector. The magnetic tool connector includes a body, a driven end at one end connectible to a driving tool, and a working end connectible to a driven object at another end. The working end includes a magnet assembly configured to magnetically attract the driven object. The working end defines a hole. The magnet assembly includes an end in thread engagement with the hole. The magnet assembly includes a housing and a magnet disposed in the housing. The magnet is located outside of the hole.

Driving the driven object can cause the driven object to impact the magnet. The magnet is also subject to vibrational disturbance. Therefore, the magnet is easily damaged.

The present invention is, therefore, intended to obviate or at least alleviate the problems encountered in the prior art.

### SUMMARY OF THE INVENTION

According to the present invention, a magnetic tool connector for driving a flat head fastener includes a main body, a driven end at a first end of the main body, and a working end at a second end of the main body. The working end defines a first chamber and a second chamber extending from and opening to the first chamber. The first chamber is configured to receive a flat head fastener to be driven. The first chamber has a first opening at an end edge of the working end. The second chamber has a second opening at an end edge of the first chamber. The end edge of the first chamber forms a horizontal abutting surface against which the flat head fastener disposed within the first chamber abuts horizontally. A magnetic assembly is slidably coupled to the main body and includes a magnet configured to magnetically attract the flat head fastener. The magnetic assembly is movable between a first position in which the magnet is located outside of the second chamber and a second position in which the magnet is located within the second chamber and is prevented from being impacted and damaged by the flat head fastener. The magnet includes an engaging side configured to abut and magnetically attract the flat head fastener, and the engaging side is flush with the horizontal abutting surface when the magnetic assembly is in the second position.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a magnetic tool connector in accordance with the present invention.

FIG. 2 is an exploded perspective view of the magnetic tool connector of the present invention.

FIG. 3 is a cross-sectional view of the magnetic tool connector of the present invention.

FIG. 4 is a cross-sectional view showing the magnetic tool connector of the present invention receiving a flat head fastener.

FIG. 5 is a cross-sectional view showing a driving tool driving the flat head fastener through the magnetic tool connector of the present invention.

FIG. 6 is a perspective view of a magnetic tool connector of a second embodiment according to the present invention.

FIG. 7 is an exploded, perspective view of the magnetic tool connector of FIG. 6.

FIG. 8 is a cross-sectional view of the magnetic tool connector of FIG. 6.

FIG. 9 is a cross-sectional view showing the magnetic tool connector of FIG. 6 receiving a flat head fastener.

FIG. 10 is a cross-sectional view showing a driving tool driving the flat head fastener through the magnetic tool connector of FIG. 6.

### DETAILED DESCRIPTION OF THE INVENTION

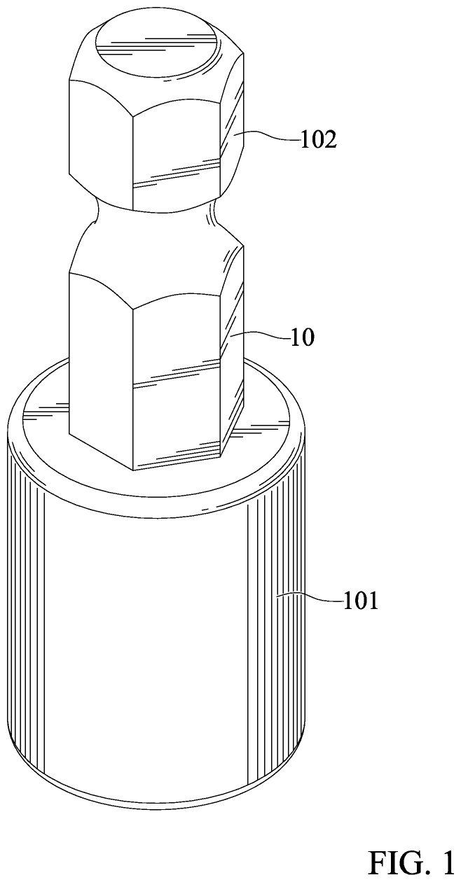

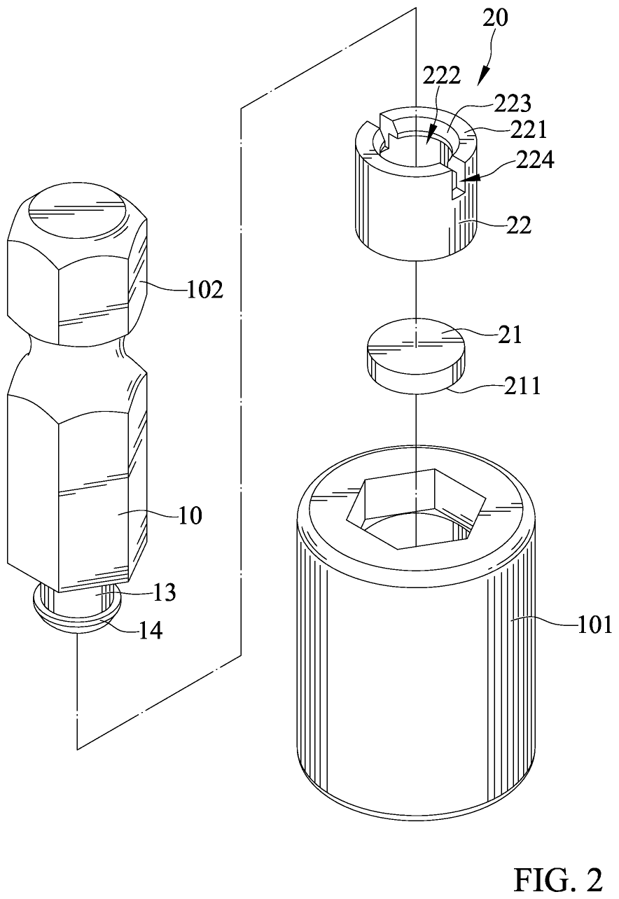

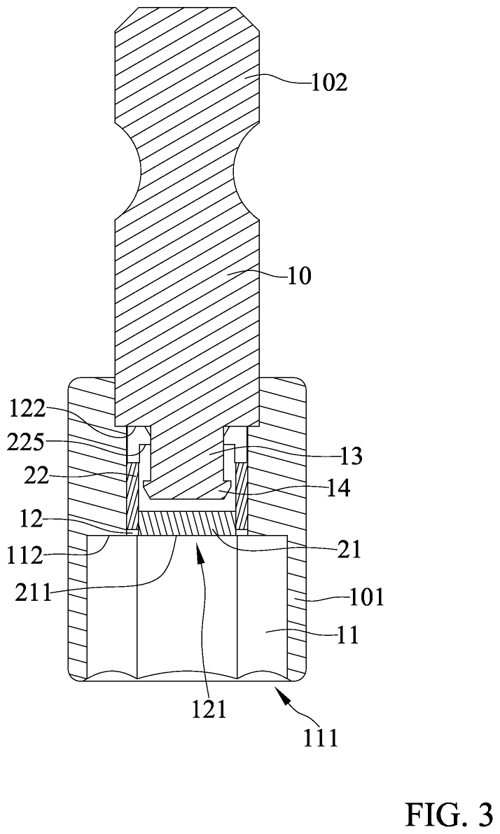

FIGS. 1 through 5 show a magnetic tool connector of the present invention. A main body 10 has a first end 101 and a second end 102 and includes a driven end at the first end 101 and a working end at the second end 102 respectively. The working end defines a first and second chamber 11 and 12. The first chamber 11 is configured to receive a flat head fastener P to be driven. The first chamber 11 has a first opening 111 at an end edge of the working end. The second chamber 12 has a second opening 121 at an end edge of the first chamber 11. The end edge ofthe first chamber 11 forms a horizontal abutting surface 112 against which the flat head fastener (P) disposed within the first chamber abuts horizontally for positioning the flat head fastener P within the first chamber 11. The first chamber 11 has a polygonal cross-section. The second chamber 12 has a circular cross-section. A distance between two opposite sides of the first chamber 11 is greater than a diameter of the second chamber 12. The first chamber 11 has a hexagonal cross-section. The housing 22 has a circular cross-section.

A magnetic assembly 20 is slidably coupled to the main body 10. The magnetic assembly 20 includes a magnet 21 configured to magnetically attract the flat head fastener P and a housing 22 supporting the magnet 21. The main body 10 includes a connecting structure and the housing 22 is slidably connected to the connecting structure. The connecting structure extends within the second chamber 12. The connecting structure includes a first shoulder 122, a guide protrusion 13, and a second shoulder 14. The first and second shoulders 122 and 14 extend at opposite ends of the guide protrusion 13. The first and second shoulders 122 and 14 extend radially outwardly from the guide protrusion 13. The second shoulder 14 is disposed in a hole 222 defined by the housing 22. The second shoulder 14 inserts in the housing 22 through the hole 222. The magnet 21 is disposed in the hole 222. The housing 22 includes a flange 223 at an end engaging the guide protrusion 13 and movably restrained between the first and second shoulders 122 and 14. The flange 223 extends annularly and has a tab protruding radially inwardly.

The main body 10 includes a first structure in a form of a shaft and a second structure in a form of a socket. The shaft includes the guide protrusion 13 and the first and second shoulders 122 and 14 at a first end thereof and the driven end at a second end thereof. The second structure defines the first and second chambers 11 and 12 and includes a first open end defined by the first opening 111. The second structure includes a second open end opposite the first open end and communicating with the second chamber 12. The guide protrusion 13 and the first and second shoulders 122 and 14 are inserted through the second open end into the second chamber 12. The shaft and the socket are not free to move with respect to each other. The shaft and socket are in tight engagement with one another.

The magnetic assembly 20 is movable between a first position in which the magnet 21 is located outside of the second chamber 12 and a second position in which the magnet 21 is located within the second chamber 12 and is prevented from being impacted and damaged by the flat head fastener P. The magnet 21 includes an engaging side 211 configured to abut and magnetically attract the flat head fastener P. The engaging side 211 is flush with the horizontal abutting surface 112 when the magnetic assembly 20 is in the second position. The engaging side 211 of the magnet 21 is not flush with the abutting surface 112 when the magnetic assembly 20 is in the first position. The engaging side 211 of the magnet 21 and the abutting surface 112 are aligned with an axis A when the magnetic assembly 20 is in the second position. Furthermore, the tab of the flange 223 has a top edge 221 selectively abutting the first shoulder 122 and a bottom edge 225 selectively abutting the second shoulder 14. When the magnetic assembly 20 is in the first position, the top edge 221 and the first shoulder 122 are not abutted with one another, and the bottom edge 225 and the second shoulder 14 are abutted with one another. When the magnetic assembly 20 is in the second position, the top edge 221 and the first shoulder 122 are abutted with one another, and the bottom edge 225 and the second shoulder 14 are not abutted with one another. In addition, the top edge 221 defines the top surface of the housing 22.

The flange 223 includes a first beveled surface extending between the top and bottom edges 221 and 225. The second shoulder 14 includes a second beveled surface. The housing 22 includes at least one groove 224 extending through inner and outer peripheries thereof. The at least one groove 224 extends radially from the hole 222. The first beveled surface faces inwardly. The second beveled surface faces outwardly. The at least one groove 224 facilitates deflection of the flange 223. The first and second beveled surfaces and the at least one groove 224 facilitate engagement of the housing 22 with the guide protrusion 13.

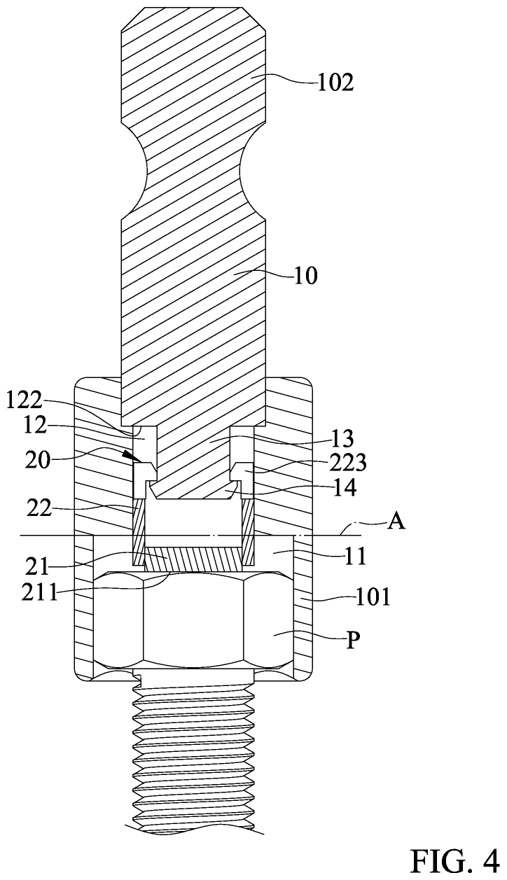

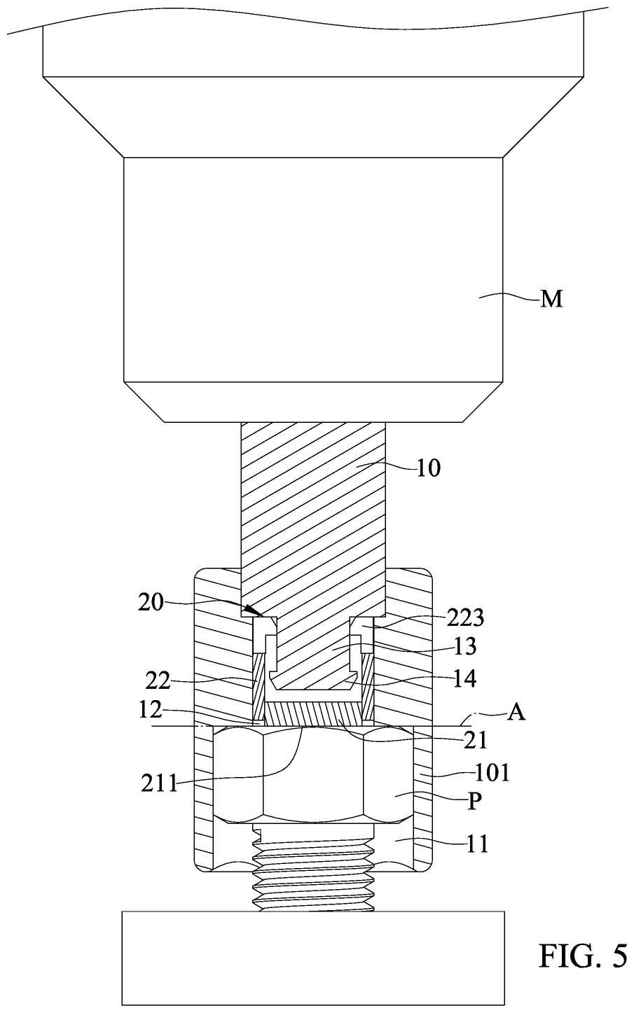

FIG. 4 shows the flat head fastener P to be driven is disposed in the first chamber 11, and the magnetic assembly 20 is in the first position. FIG. 5 shows a driving tool M can engage the driven end to drive the magnetic tool connector. When the flat head fastener P is driven into another object, the flat head fastener P is rest on the abutting surface 112, and the magnetic assembly 20 is moved to the second position.

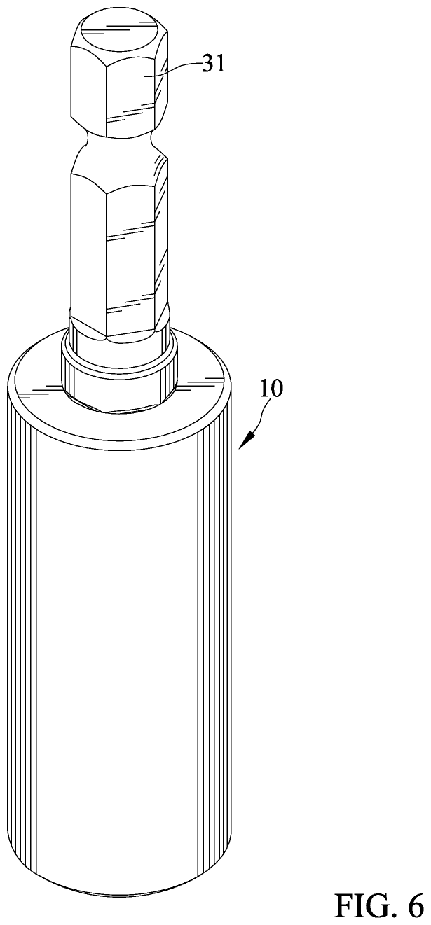

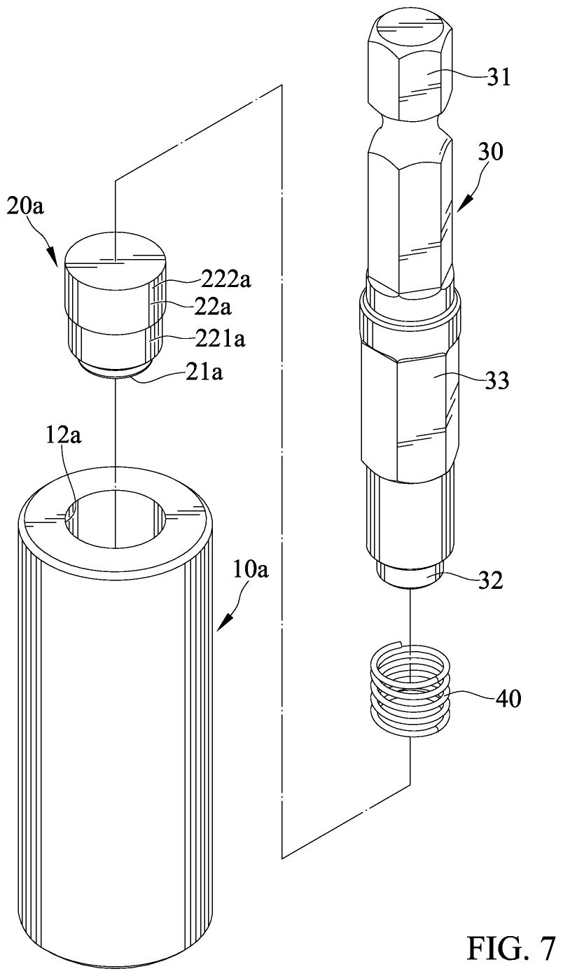

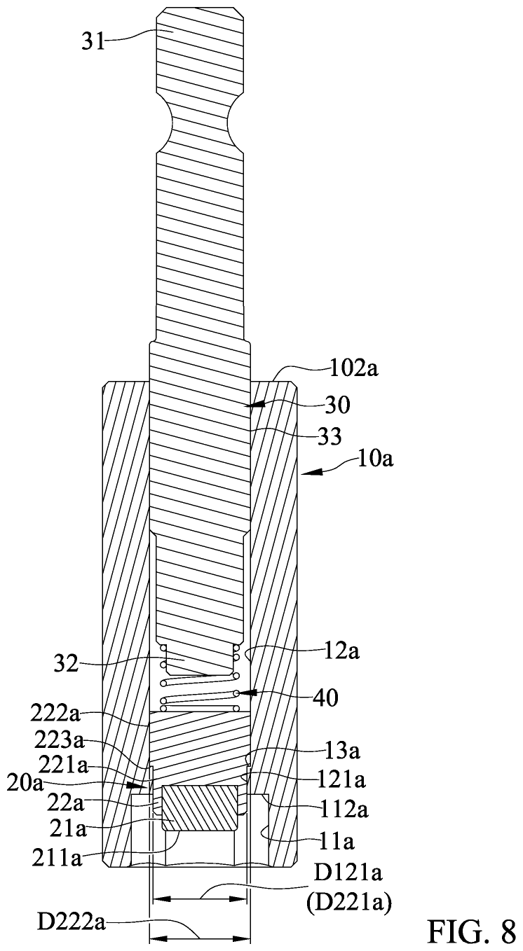

FIGS. 6 through 10 show a magnetic tool connector of a second embodiment according to the present invention. The second embodiment is substantially the same as the first embodiment except that the second chamber 12a penetrates through the second end 102a of the main body 10a to form an assembling opening at the second end 102a. The magnetic tool connector of the second embodiment further includes a connecting member 30 and an elastic member 40.

The connecting member 30 is fixedly coupled to the second chamber 12a via the assembling opening and has a driven end 31 and a supporting end 32. Further, the first chamber 11a has a polygonal cross-section, and the second chamber 12a has a circular cross-section. The connecting member 30 has a connecting section 33 formed between the driven end 31 and the supporting end 32. The connecting section 33 has a polygonal cross-section and is fixedly coupled to the second chamber 12a, so as to allow the connecting member 30 and the elastic member 40 to be assembled sequentially with respect to the second chamber 12a. Thus, the magnetic tool connector of the second embodiment can easily be assembled.

The elastic member 40 is arranged between the magnetic assembly 20a and the connecting member 30. Two opposite ends of the elastic member 40 elastically abut against the magnetic assembly 20a and the supporting end 32, respectively.

The magnetic assembly 20a includes a sliding member 22a slidably disposed in the second chamber 12a. The magnet 21a is supported by one end of the sliding member 22a, and the elastic member 40 elastically abuts against the other end of the sliding member 22a. Thus, the elastic member 40 may be a compression spring for biasing the sliding member 22a.

The second opening 121a is formed as a circular hole with an inner diameter D121a. The sliding member 22a has a first section 221a and a second section 222a integrally formed therein. Both of the first and second sections 221a and 222a have circular cross-sections. Further, the first section 221a has a first outer diameter D221a, and the second section 222a has a second outer diameter D222a greater than the first outer diameter D221a to form an abutting face 223a between the first and second sections 221a and 222a. The inner diameter D121a is less than the second outer diameter D222a but not less than the first outer diameter D221a to prevent the sliding member 22a falls out of the second chamber 12a.

The main body 10a has a shoulder 13a formed between the first and second chambers 11a and 12a and selectively abutted against the abutting face 223a to limit the sliding member 22a. The second opening 121a penetrates through the shoulder 13a to cause the first and second chambers 11a and 12a in communication each other.

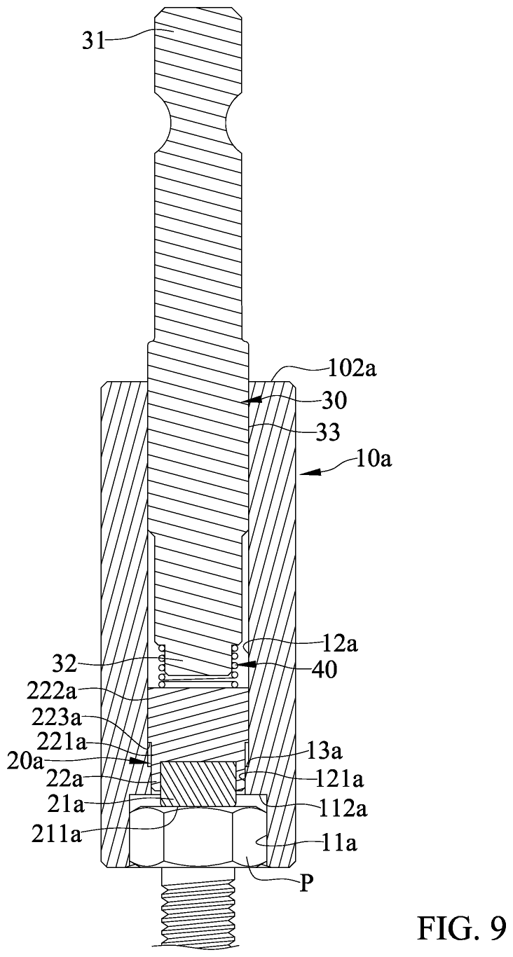

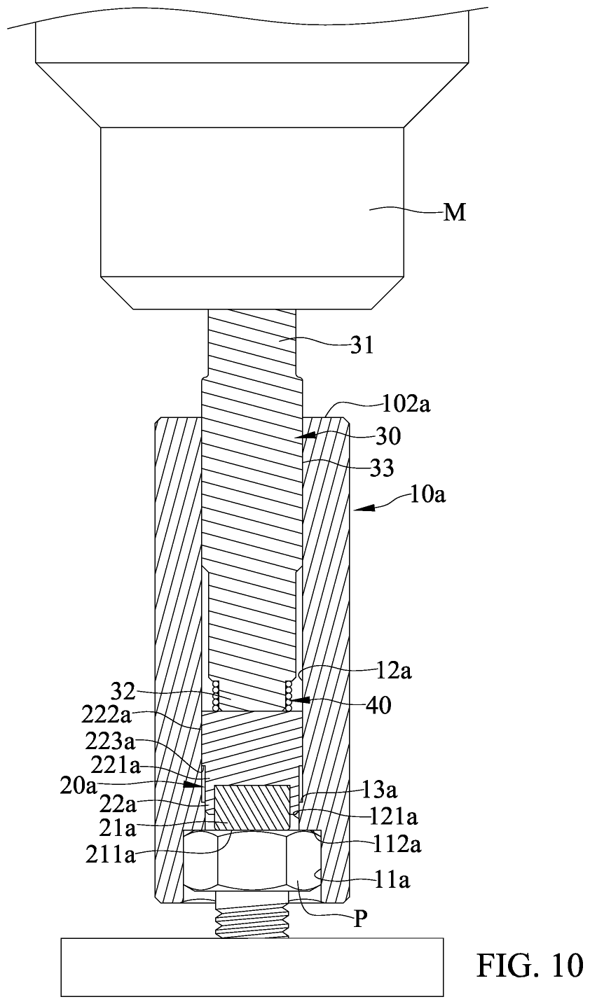

FIG. 9 shows the flat head fastener P to be driven is disposed in the first chamber 11a, and the magnetic assembly 20a is in the first position. FIG. 10 shows a driving tool M can engage the driven end 31 to drive the magnetic tool connector. When the flat head fastener P is driven into another object, the flat head fastener P is rest on the abutting surface 112a, and the magnetic assembly 20a is moved to the second position.

In view of the foregoing, the magnets 21 and 21a are located within the second chambers 12 and 12a when the magnetic assemblies 20 and 20a are in the second position, the engaging sides 211 and 211a of the magnets 21 and 21a and the abutting surfaces 112 and 112a are flush with one another and are aligned with the axis A, and the abutting surfaces 112 and 112a prevent the flat head fastener P from impacting the magnets 21 and 21a. Therefore, the magnets 21 and 21a are not impacted and damaged by the flat head fastener P.

The foregoing is merely illustrative of the principles of this invention, and various modifications can be made by those skilled in the art without departing from the scope and spirit of the invention.

What is claimed is:

1. A magnetic tool connector for driving a flat head fastener comprising:
a main body, a driven end at a first end of the main body, and a working end at a second end of the main body, wherein the working end defines a first chamber and a second chamber extending from and opening to the first chamber, wherein the first chamber is configured to receive a flat head fastener to be driven, wherein the first chamber has a first opening at an end edge of the working end, wherein the second chamber has a second opening at an end edge of the first chamber, wherein the end edge of the first chamber forms a horizontal abutting surface against which the flat head fastener disposed within the first chamber abuts horizontally; and
a magnetic assembly slidably coupled to the main body and including a magnet configured to magnetically attract the flat head fastener, wherein the magnetic assembly is movable between a first position in which the magnet is located outside of the second chamber and a second position in which the magnet is located within the second chamber and is prevented from being impacted and damaged by the flat head fastener, and wherein the magnet includes an engaging side configured to abut and magnetically attract the flat head fastener, and the engaging side is flush with the horizontal abutting surface when the magnetic assembly is in the second position.

2. The magnetic tool connector as claimed in claim 1, wherein the magnetic assembly includes a housing and the magnet is supported by the housing, wherein the housing is slidably coupled to the main body.

3. The magnetic tool connector as claimed in claim 2, wherein the main body includes a connecting structure and the housing is slidably connected to the connecting structure, wherein the connecting structure extends within the second chamber.

4. The magnetic tool connector as claimed in claim 3, wherein the connecting structure includes a first shoulder, a guide protrusion, and a second shoulder, with the first and second shoulders extending at opposite ends of the guide protrusion, wherein the housing includes a flange at an end engaging the guide protrusion and movably restrained between the first and second shoulders.

5. The magnetic tool connector as claimed in claim 4, wherein the flange extends annularly and has a tab protruding radially inwardly, and wherein the tab has a top edge selectively abutting the first shoulder and a bottom edge selectively abutting the second shoulder, wherein when the magnetic assembly is in the second position, the top edge and the first shoulder are not abutted with one another, and the bottom edge and the second shoulder are abutted with one another, and wherein when the magnetic assembly is in the second position, the top edge and the first shoulder are abutted with one another, and the bottom edge and the second shoulder are not abutted with one another.

6. The magnetic tool connector as claimed in claim 5, wherein the flange includes a first beveled surface extending between the top and bottom edges, wherein the second shoulder includes a second beveled surface, and wherein the housing includes at least one groove extending through inner and outer peripheries thereof.

7. The magnetic tool connector as claimed in claim 4, wherein the second shoulder is disposed in a hole defined by the housing, and wherein the magnet is disposed in the hole.

8. The magnetic tool connector as claimed in claim 1, wherein the first chamber has a polygonal cross-section, wherein the second chamber has a circular cross-section, and wherein a distance between two opposite sides of the first chamber is greater than a diameter of the second chamber.

9. The magnetic tool connector as claimed in claim 4, wherein the first chamber has a polygonal cross-section, wherein the second chamber has a circular cross-section, and wherein a distance between two opposite sides of the first chamber is greater than a diameter of the second chamber.

10. The magnetic tool connector as claimed in claim 4, wherein the main body includes a first structure in a form of a shaft and a second structure in a form of a socket, and wherein the second structure defines the first and second chambers and includes a first open end defined by the first opening.

11. The magnetic tool connector as claimed in claim 10, wherein the second structure includes a second open end opposite the first open end and communicating with the second chamber.
